(19) United States
(12) Patent Application Publication
(10) Pub. No.: US 2006/0103287 A1
(43) Pub. Date: May 18, 2006

(54) CARBON-NANOTUBE COLD CATHODE AND METHOD FOR FABRICATING THE SAME

(76) Inventor: LI-REN TSUEI, TAIPEI COUNTY (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/904,519

(22) Filed: Nov. 15, 2004

(51) Int. Cl. H01J 1/02; H01J 1/14; H01J 9/04

(52) U.S. Cl. 313/311; 313/310; 313/309; 445/50; 445/51

(57) ABSTRACT

A method for fabricating a carbon-nanotube cold cathode is described. A conductive layer is formed on a substrate, and then a metal film is selectively formed on predetermined emitter regions of the conductive layer. An anodization treatment is done to the metal film to form numerous nanopores through the metal film. Thereafter, carbon nanotubes are deposited into the nanopores through electrodeposition, wherein one end of each carbon nanotube is exposed outside a corresponding nanopore of the metal film.

### BACKGROUND OF THE INVENTION

1. Field of the Invention

The present invention relates to an electronic element and a method for fabricating the same. More particularly, the present invention relates to a carbon-nanotube cold cathode and a method for fabricating the same with electrodeposition.

2. Description of Related Art

Recently, various types of flat panel display (FDP) are developed to replace traditional CRT displays, featuring much less weight and thickness, low energy consumption and reduction/elimination of harmful electromagnetic radiation. Today, the most popular type of FDP is surely the liquid crystal display (LCD). However, other types of FPD, including plasma display, projection-type display, organic electroluminescent (OEL) display and field emission display (FED), are also attracting much attention. It is expected that these types of FDP would be superior in cost reduction and performance, especially in energy saving, resolution, response time, brightness, contrast and viewing angle.

Among these types of FDP, the most promising one should be FED, which functions similar to a conventional CRT. A FED essentially includes a cathode substrate and an anode substrate, wherein the cathode substrate is formed with an array of thin-film cold field emitters thereon to constitute a “cold cathode”, and the anode substrate is coated with phosphors. The cathode substrate and the anode substrate enclose a vacuum, and the field emitters are applied with voltages to emit electrons, which will collide with the phosphors to make them emit lights.

The earliest field emitter is the Spindt-type emitter, which includes a miniature cavity and a metal cone with a sharp point formed therein, wherein the miniature cavity is defined using a lithography method and the metal cone formed with evaporation deposition. However, since the lithography method and the evaporation deposition are limited in the substrate size, the dimensions of FED are restricted correspondingly. Moreover, the tip of such an emitter is degraded rapidly, decreasing the lifetime of FED.

In view of this, using carbon nanotubes (CNT) to fabricate a cold cathode is proposed, because carbon nanotubes not only have a high aspect ratio and small tip curvature radius to cause large emission current under low turn-on field, but also has high mechanical strength and chemical stability. For example, U.S. Pat. No. 6,359,383 to Chuang, et al. discloses a method of forming a CNT emitter array using screen-printing, and Jun Cheol Bae, et al. discloses a method for depositing carbon nanotubes in Physica B, Vol. 323, p. 168-170 (2002). However, the carbon nanotubes applied to the cathode substrate with such methods are mostly parallel to the substrate surface, so that the electron emission efficiency is poor. Moreover, the screen-printing process in the method of U.S. Pat. No. 6,359,383 requires a large amount of carbon nanotubes, and the coating slurry and the screen used in the screen-printing process are easily contaminated.

Another method for fabricating a carbon-nanotube cold cathode is to grow carbon nanotubes vertically on a catalytic metal film, which is selectively formed on a cathode substrate, using a CVD method under 800-900° C. Though the carbon nanotubes can be formed selectively with vertical orientation and uniform distribution, the process temperature is too high to apply to a glass cathode substrate. Meanwhile, the carbon nanotubes formed with CVD have poor electron emission efficiency.

### SUMMARY OF THE INVENTION

In view of the foregoing, this invention provides a carbon-nanotube cold cathode and a method for fabricating the same, which can implant carbon nanotubes to a cathode substrate substantially vertical to the surface thereof under low temperature. Therefore, the cold cathode can have high electron emission efficiency.

The method for fabricating a carbon-nanotube cold cathode of this invention is described as follows. A conductive layer is formed on a substrate, and then a metal film is selectively formed on predetermined emitter regions of the conductive layer. An anodization treatment is done to the metal film to form numerous nanopores through the metal film. Thereafter, carbon nanotubes are deposited into the nanopores through electrodeposition, wherein one end of each carbon nanotube is exposed outside a corresponding nanopore of the metal film.

Accordingly, the carbon-nanotube cold cathode of this invention includes a cathode substrate, a conductive layer on the cathode substrate, a metal film on the conductive layer and numerous carbon nanotubes. The metal film has numerous through nanopores therein, and the carbon nanotubes are deposited in the nanopores, wherein one end of each carbon nanotube is exposed outside a corresponding nanopore of the metal film.

Since the anodized metal film having nanopores therein can serve as a template for the carbon nanotubes in the electrodeposition step, the carbon nanotubes can be orientated substantially vertical to the surface of the cathode substrate to improve electron emission efficiency. Moreover, the through nanopores in the metal film are formed uniformly, so that the carbon nanotubes are distributed uniformly on the substrate. Furthermore, since the carbon nanotubes are deposited substantially vertical to the surface of the cathode substrate, the density of carbon nanotube on the cold cathode can be increased to further increase the emission current density. In addition, the temperature for electrodeposition is so low that a glass cathode substrate can be used.

It is to be understood that both the foregoing general description and the following detailed description are exemplary, and are intended to provide further explanation of the invention as claimed.

### BRIEF DESCRIPTION OF THE DRAWINGS

FIGS. 1-5 illustrate a process flow of fabricating a carbon-nanotube cold cathode according to a preferred embodiment of this invention, wherein FIG. 5 also shows the resulting carbon-nanotube cold cathode.

### DESCRIPTION OF THE PREFERRED EMBODIMENTS

Referring to FIG. 1, a plate-like cathode substrate 10 is provided, which is a glass substrate, a silicon-based substrate or an aluminum oxide substrate, for example. A conductive layer 20 is then deposited on the cathode substrate 10 through evaporation deposition or sputtering deposition. The material of the conductive layer 20 is, for example, TiN or Ti.

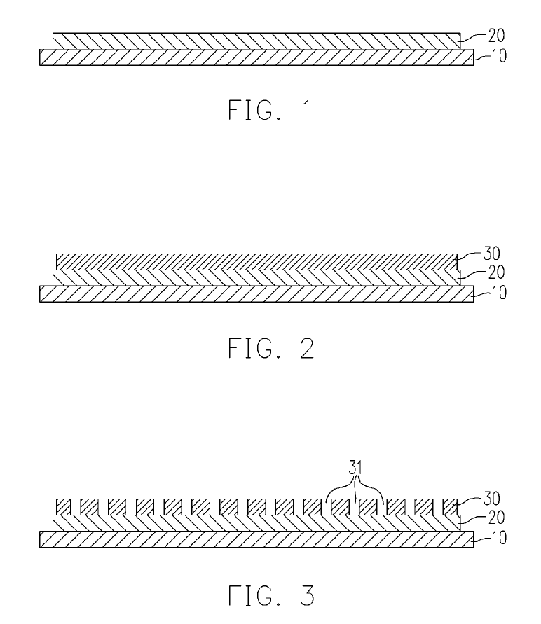

Referring to FIG. 2, a metal film 30 is selectively formed on the conductive layer 20 through, for example, evaporation deposition or sputtering deposition. The thickness of the metal film 30 is smaller than the length of the carbon nanotubes that will be deposited latter, and the material of the metal film 30 may be aluminum, for example.

Referring to FIG. 3, an anodization treatment is done to the metal film 30 to form numerous nanopores 31 through the metal film 30. The nanopores 31 are formed uniformly and have a diameter from about 5 nm to 500 nm. The distribution density and the diameter of the nanopores 31 can be adjusted by varying the composition of the electrolytic solution and/or the voltage used in the anodization process.

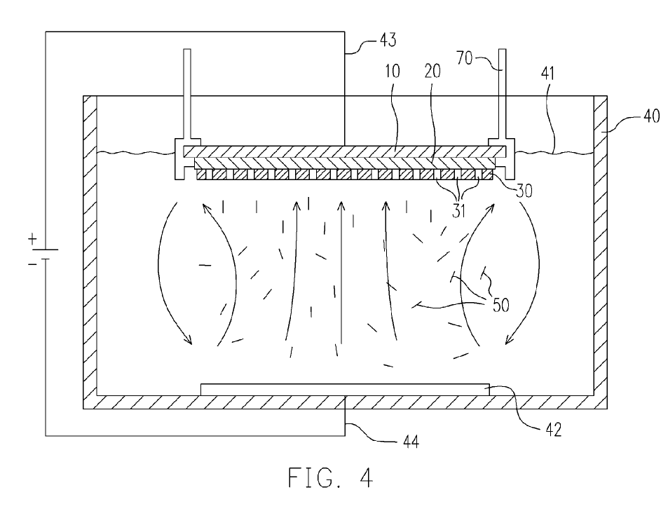

Thereafter, carbon nanotubes are deposited onto the cathode substrate 10 through electrodeposition. The electrodeposition process may include electrophoretic deposition or electrolytic deposition, while this embodiment utilizes an electrophoretic deposition method as illustrated in FIG. 4. In the electrodeposition process, carbon nanotubes 50, surfactants and electrolytes having a certain weight ratio are added into distilled water, and the resulting mixture is well stirred to be an electrolytic solution 41 containing carbon nanotubes 50 and then transferred into an electrophoretic cell 40. In this embodiment, the carbon nanotubes 50 are negatively charged by the electrolytes in the electrolytic solution 41.

Thereafter, a holder 70 is used to hold the cathode substrate 10 at its edges and place the cathode substrate 10 in the electrolytic solution 41 filled in the electrophoretic cell 40, and a counter electrode 42 is immersed in the electrolytic solution 41. The cathode substrate 10 is preferably placed parallel to the counter electrode 42, so that a uniform electric field can be created to enhance the uniformity of the carbon-nanotube deposition. Meanwhile, the cathode substrate 10 is preferably situated so that only the surface formed with the conductive layer 20 thereon is in the electrolytic solution 41. In addition, the electrophoretic cell 40 can be made into a close system to prevent any possible contamination and loss of carbon nanotubes.

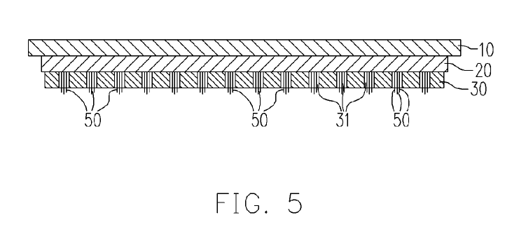

Referring to FIG. 4 again, a voltage difference is then applied between the conductive layer 20 on the cathode substrate 10 and the counter electrode 42. The conductive layer 20 on the cathode substrate 10 is connected to the positive terminal of the power supply via a line 43 to attract the negatively-charged carbon nanotubes, and the counter electrode 42 is connected to the negative terminal via a line 44. Thus, the carbon nanotubes 50 in the electrolytic solution 41 are attracted by the conductive layer 20, and are forced to deposit in the nanopores 31 substantially perpendicular to the surface of the cathode substrate 10 due to the limited size of the nanopores 31. Since the thickness of the metal film 30 is smaller than the length of the carbon nanotubes 50, as mentioned above, one end of each carbon nanotube 50 is exposed outside the corresponding nanopore 31, as shown in FIG. 5. After a certain period, the cathode substrate 10 is taken out from the electrophoretic cell 40 and then dried to complete the manufacturing process.

Moreover, the electrolytic solution 41 may be further flowed toward the cathode substrate 10 in the electrophoretic deposition, as indicated by the arrows in FIG. 4, so that the carbon nanotubes 50 can be deposited more uniformly onto the cathode substrate 10. The flow of the electrolytic solution 41 can be generated by using a stirrer (not shown), for example. This approach is particularly useful in fabrication of large-sized CNT cold cathodes.

FIG. 5 also illustrates the structure of the carbon-nanotube cold cathode fabricated with the above steps. The carbon-nanotube cold cathode includes a cathode substrate 10, a conductive layer 20 on the cathode substrate 10, a metal film 30 on the conductive layer 20 and numerous carbon nanotubes 50. The metal film 30 has numerous through nanopores 31 therein, and the carbon nanotubes 50 are deposited in the through nanopores 31 substantially vertical to the surface of the cathode substrate 10, wherein one end of each carbon nanotube 50 is exposed outside a corresponding nanopore 31 of the metal film 30.

Since the anodized metal film having nanopores therein can serve as a template for the carbon nanotubes, the carbon nanotubes can be orientated substantially vertical to the surface of the cathode substrate to improve electron emission efficiency. Meanwhile, the through nanopores in the metal film are formed uniformly, so that the carbon nanotubes are distributed uniformly on the substrate. In addition, since the carbon nanotubes are deposited substantially vertical to the surface of the cathode substrate, the density of carbon nanotube on the cold cathode can be increased to further increase the emission current density. Furthermore, the temperature for electrodeposition is so low that a glass cathode substrate can be used.

Moreover, since the electrophoretic cell can be made into a close system in the electrodeposition process, the required amount of carbon nanotubes is less than that in the conventional screen-printing method, and contamination of the cold cathode can also be prevented.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A method for fabricating a carbon-nanotube cold cathode, comprising:
forming a conductive layer on a cathode substrate;
forming a metal film on the conductive layer;
performing an anodization treatment to the metal film to form a plurality of nanopores through the metal film; and
depositing carbon nanotubes into the nanopores through electrodeposition, wherein one end of each carbon nanotube is exposed outside a corresponding nanopore of the metal film.

2. The method of claim 1, wherein the electrodeposition process comprises:
providing an electrolytic solution containing carbon nanotubes;
placing the cathode substrate and a counter electrode in the electrolytic solution; and
applying a voltage difference between the conductive layer on the cathode substrate and the counter electrode, such that the carbon nanotubes are attracted toward the cathode substrate.

3. The method of claim 2, wherein the cathode substrate and the counter electrode are placed substantially parallel to each other.

4. The method of claim 3, wherein the counter electrode is immersed in the electrolytic solution, and the cathode substrate is placed in the electrolytic solution and over the counter electrode with only one surface of the conductive layer.

5. The method of claim 2, wherein the electrolytic solution containing carbon nanotubes is further flowed toward the cathode substrate in the electrodeposition process.

6. The method of claim 1, wherein the cathode substrate comprises a glass substrate, a silicon-based substrate or an aluminum oxide substrate.

7. The method of claim 1, wherein the conductive layer is formed on the cathode substrate through evaporation deposition or sputtering deposition.

8. The method of claim 1, wherein the conductive layer comprises TiN or Ti.

9. The method of claim 1, wherein the metal film is formed on the conductive layer through evaporation deposition or sputtering deposition.

10. The method of claim 1, wherein the metal film comprises metallic aluminum.

11. The method of claim 1, wherein the diameter of the nanopores formed in the metal film ranges from 5 nm to 500 nm.

12. A carbon-nanotube cold cathode, comprising:
a cathode substrate;
a conductive layer on the cathode substrate;
a metal film on the conductive layer, having a plurality of through nanopores; and
a plurality of carbon nanotubes deposited in the through nanopores, wherein one end of each carbon nanotube is exposed outside a corresponding nanopore of the metal film.

13. The carbon-nanotube cold cathode of claim 12, wherein the cathode substrate comprises a glass substrate, a silicon-based substrate or an aluminum oxide substrate.

14. The carbon-nanotube cold cathode of claim 12, wherein the conductive layer comprises TiN or Ti.

15. The carbon-nanotube cold cathode of claim 12, wherein the metal film comprises metallic aluminum.

16. The carbon-nanotube cold cathode of claim 12, wherein the diameter of the through nanopores ranges from 5 nm to 500 nm.
